(19) United States
(12) Patent Application Publication
(10) Pub. No.: US 2010/0131288 A1
(43) Pub. Date: May 27, 2010

(54) IDENTIFICATION AND RECONCILIATION OF MISSED OR ERRONEOUS PROVIDER CHARGES

(75) Inventors: William R. Curran, Reston, VA (US); David J. Curran, Reston, VA (US)

Correspondence Address: STERNE, KESSLER, GOLDSTEIN & FOX P.L.L.C., 1100 NEW YORK AVENUE, N.W., WASHINGTON, DC, 20005, US

(73) Assignee: AcuStream, LLC, Great Falls, VA (US)

(21) Appl. No.: 12/624,066

(22) Filed: Nov. 23, 2009

Related U.S. Application Data
(60) Provisional application No. 61/193,400, filed on Nov. 24, 2008.

(51) Int. Cl. G06Q 30/00; G06Q 10/00; G06Q 50/00

(52) U.S. Cl. 705/2; 705/30; 705/34

(57) ABSTRACT

A system, method, and computer program product are provided for using rules to identify missing charges with charge data. In accordance with an embodiment of the present invention, a transaction representing an individual patient visit is identified, and missing charges within the transaction are determined based on application of the rules. For example, a rule can be applied to detect a missing charge when a charge for surgery appears without the appearance of a corresponding charge for anesthesia.

### CROSS-REFERENCE TO RELATED APPLICATIONS

This patent application claims the benefit of U.S. Provisional Patent Application No. 61/193,400 (Atty. Dkt. No. 2897.0010000), filed Nov. 24, 2008, entitled “System and Method for Automating the Identification and Reconciliation of Missed or Error Provider Charges,” which is incorporated herein by reference in its entirety.

### BACKGROUND OF INVENTION

1. Field of the Invention

The present invention relates generally to billing, and, more specifically, to identification of charges based on rules.

2. Description of the Background Art

Running a successful service organization requires proper collection of payment for services performed. This requires an already busy service provider, such as a physician, to routinely enter charges into a billing system. For particularly busy providers, it may be difficult to mentally track all of the services performed before finding the opportunity to enter the charges. As a result, it is likely that over time a number of such charges will be missed.

Previous study on the problem has concentrated primarily on optimizing the accuracy of entered charges. This approach helps reduce rejections by payers, such as insurance providers, by helping the service provider enter the charges in a manner that correctly details the charge.

FIG. 1 illustrates a conventional billing system 100. The conventional billing system 100 is comprised of a legacy provider system 102 into which charges are input 101. These charges are then submitted 104 to a payer 106, such as an insurance company.

The focus of past solutions has been in optimizing the reliability of the charge input 101, such that these charges, when submitted 104, are less likely to be rejected by payer 106. However, these solutions do not solve the problem of missed charges. As noted above, it is difficult for many service providers to reliably provide every single charge for the services performed on a consistent basis.

In a private medical practice, for example, a physician's income is directly tied to the practice's profits made through accurate and complete billing practices. However, in large physicians' organizations or teaching hospitals, where many of the medical professionals are salaried, it can be difficult to ensure every procedure is accounted for and billed. Some physicians can perform dozens of procedures a day, invariably leading to a number of those charges being missed on a regular basis.

Additionally, in an effort to push charges through to payers as quickly as possible, legacy provider system 102 generally bills out services as soon as they are ready. If two physicians attend to a patient in a single stay, and the first physician diligently enters the charges within a few days, while the other would wait months, it is difficult to manually reconcile these charges using current technology.

Missed charges can severely cut into such an organization's bottom line. Procedures that would otherwise be billed for thousands of dollars go unbilled, and thus never collected.

Accordingly, what is desired is a system and method for identifying charges and allowing verified charges to be timely billed.

### SUMMARY OF INVENTION

Embodiments of the invention include a method comprising accessing charge data in one or more processors, identifying, in the one or more processors, a transaction in the charge data corresponding to an identifier, the transaction comprising one or more charges in the charge data, applying, in the one or more processors, a rule to identify a missing charge within the transaction, and transmitting, in the one or more processors, a notification to a verifier of the missing charge.

Another embodiment of the invention includes a computer-readable medium having computer-executable instructions stored thereon that, upon execution by a computing device, cause the computing device to perform a method comprising accessing charge data, identifying a transaction in the charge data corresponding to an identifier, the transaction comprising one or more charges in the charge data, applying a rule to identify a missing charge within the transaction, and transmitting a notification to a verifier of the missing charge.

Further embodiments of the present invention include a system comprising a memory configured to store modules comprising an accessing module configured to access charge data, an identifying module configured to identify a transaction in the charge data corresponding to an identifier, the transaction comprising one or more charges in the charge data, an applying module configured to apply a rule to identify a missing charge within the transaction, and a transmitting module configured to transmit a notification to a verifier of the missing charge, and one or more processors configured to process the modules.

Additional embodiments of the present invention include a method comprising providing charge data to a computing device configured to identify a missing charge within a transaction of the charge data, accessing the missing charge from the computing device, verifying that a service corresponding to the missing charge was performed, updating the status of the missing charge in the computing device, and submitting subsequent charge data to the computing device further configured to reconcile the missing charge with the subsequent charge data.

Yet another embodiment of the present invention includes a method comprising accessing charge data in one or more processors, identifying, in the one or more processors, a transaction in the charge data corresponding to an identifier, the transaction comprising one or more charges in the charge data, applying, in the one or more processors, a rule profile to identify a charge related to at least one charge of the transaction, and transmitting, in the one or more processors, a notification to a verifier of the related charge, without requiring separate entry of the related charge.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form a part of the specification, illustrate embodiments of the present invention and, together with the description, further serve to explain the principles of the invention and to enable a person skilled in the relevant art to make and use the invention.

FIG. 1 illustrates a conventional billing system.

FIG. 2 illustrates a billing system, in accordance with an embodiment of the present invention.

FIG. 3A is a login screen, in accordance with an embodiment of the present invention.

FIG. 3B is a registration screen, in accordance with an embodiment of the present invention.

FIG. 3C shows an administrator account management view, in accordance with an embodiment of the present invention.

FIG. 4 illustrates a rules creation or modification interface 400, in accordance with an embodiment of the present invention.

FIG. 5 is a report illustrating missing charges, in accordance with an embodiment of the present invention.

FIG. 6 is a sorting options display, in accordance with an embodiment of the present invention.

FIG. 7A is a view of the REVBUILDER interface with the “Batch” menu selected, in accordance with an embodiment of the present invention.

FIG. 7B is a batch interface, in accordance with an embodiment of the present invention.

FIG. 8A is a view of the REVBUILDER interface with the “Reports” menu selected, in accordance with an embodiment of the present invention.

FIG. 8B is a view of the missing charges report interface, in accordance with an embodiment of the present invention.

FIG. 8C illustrates a resulting sample report output in CSV format and opened as a spreadsheet for viewing, in accordance with an embodiment of the present invention.

FIG. 9 is a flowchart illustrating steps by which a report showing identified missing charges is generated, in accordance with an embodiment of the present invention.

FIG. 10 is a flowchart illustrating steps by which missing charges are reconciled by a user, in accordance with an embodiment of the present invention.

FIG. 11 is a flowchart illustrating steps by which a data roll-up occurs, in accordance with an embodiment of the present invention.

FIG. 12 depicts an example computer system in which embodiments of the present invention may be implemented.

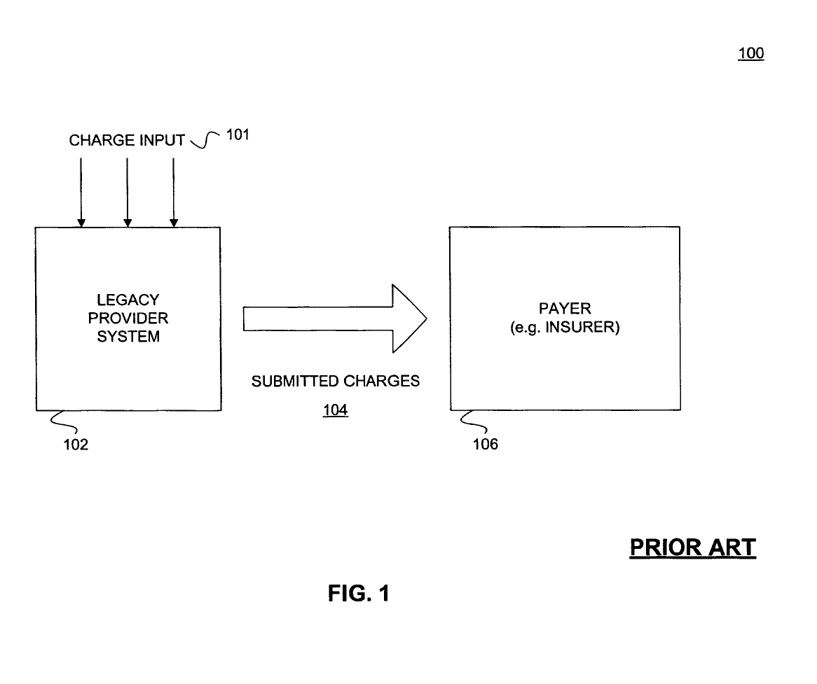

The present invention will now be described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

### I. Introduction

The following detailed description of the present invention refers to the accompanying drawings that illustrate exemplary embodiments consistent with this invention. Other embodiments are possible, and modifications can be made to the embodiments within the spirit and scope of the invention. Therefore, the detailed description is not meant to limit the invention. Rather, the scope of the invention is defined by the appended claims.

It would be apparent to one of skill in the art that the present invention, as described below, can be implemented in many different embodiments of software, hardware, firmware, and/or the entities illustrated in the figures, as well as combinations thereof. Any actual software code with the specialized control of hardware to implement the present invention is not limiting of the present invention. Thus, the operational behavior of the present invention will be described with the understanding that modifications and variations of the embodiments are possible, given the level of detail presented herein.

References to systems used in the healthcare industry are made throughout the specification. However, one skilled in the relevant arts will appreciate that the embodiments discussed herein can have application outside of the healthcare industry, such as in other service industries and retail businesses. While embodiments will generally be discussed in the context of the healthcare industry using examples therefrom, occasional examples are provided regarding usage in other contexts. Such examples are not limiting, and do not convey the only aspects of the embodiments discussed herein for which alternative applications exist. One skilled in the relevant arts will readily appreciate the utility of the embodiments in other contexts, and therefore applicability to the healthcare industry is provided by way of example, and not limitation.

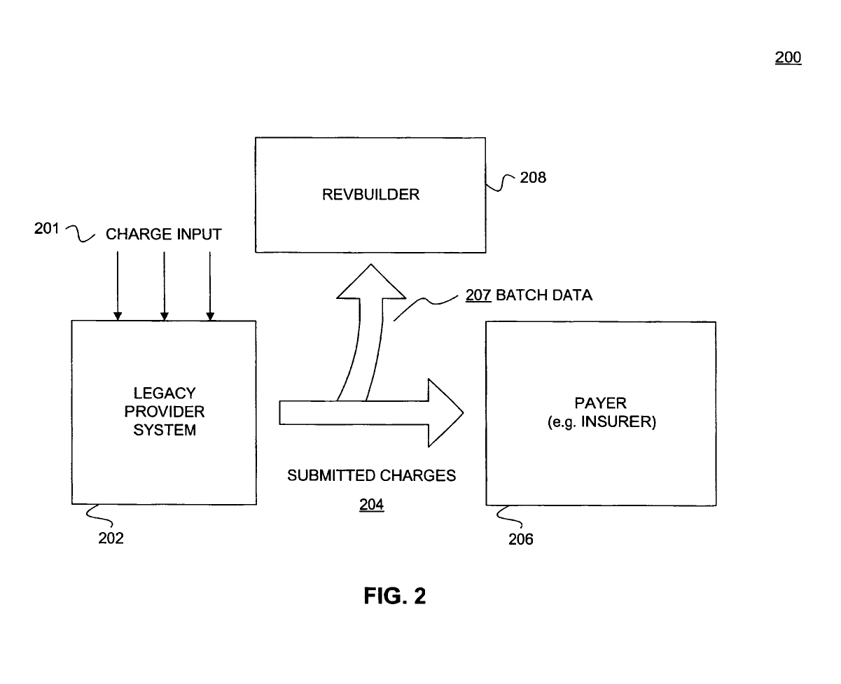

FIG. 2 illustrates a billing system 200, in accordance with an embodiment of the present invention. The billing system 200 comprises a legacy provider system 202 into which charge inputs 201 are made, in accordance with an embodiment of the present invention. Legacy provider system 202 could be one of many existing medical billing systems, such as MCKESSON PRACTICE COMPLETE, developed by MCKESSON CORPORATION of San Francisco, Calif.; CENTRICITY ENTERPRISE (part of CENTRICITY SOLUTIONS), developed by GE HEALTHCARE (IDX) of the United Kingdom, a unit of GENERAL ELECTRIC COMPANY; PRACTICE MANAGEMENT, developed by EPIC SYSTEMS CORPORATION of Verona, Wis.; CERNER MILLENNIUM REVENUE CYCLE SOLUTIONS, developed by CERNER CORPORATION of Kansas City, Mo.; REVENUE OPTIMIZATION AND CHARGE CAPTURE, developed by PATIENTKEEPER, INC. of Newton, Mass.; ATHENACOLLECTOR and ATHENACLINICALS developed by ATHENAHEALTH, INC. of Watertown, Mass.; and REVENUE CYCLE AND ACCESS MANAGEMENT SOLUTIONS, ENTERPRISE PERFORMANCE MANAGEMENT, AND HER/PRACTICE MANAGEMENT SUITE developed by ECLIPSYS CORPORATION of Atlanta, Ga., in accordance with an embodiment of the present invention.

In the medical context, a physician will input charges some time after a procedure has been performed using the charge input 201 facilities of legacy provider system 202. These charges are then collected and submitted 204 to one or more payers 206. For medical billings, payer 206 is commonly an insurer, or the patient who received the services.

The format used by legacy provider system 202 to prepare the charges 204 for submission generally depends on the receiving payer 206. At some point, the charges 204 exist in an electronic format within legacy provider system 202. These electronic format charges can be reformatted to conform to payer 206 requirements and sent electronically. Alternatively, a printout of the charges 204 can be generated for sending to other payers, such as patients. One skilled in the relevant arts will appreciate that charge data 204 may be provided in any suitable format, and the use of electronic records herein is presented by way of example, and not limitation.

Along with the submission of charges 204, a collection of charges for a time period are then combined into a batch 207 and sent to the REVBUILDER system 208, in accordance with an embodiment of the present invention. REVBUILDER is the product name used by ACUSTREAM of Great Falls, Va. to refer to an exemplary embodiment of the present invention for the capture of missed charges. One skilled in the relevant arts will therefore recognize that reference to REVBUILDER encompasses any system that embodies the disclosed features of the REVBUILDER system 208, and is used by way of example, and not limitation.

REVBUILDER system 208 receives batch data 207 containing charges for a selectable time period, such as for the past month, in accordance with an embodiment of the present invention. In accordance with an additional embodiment of the present invention, batch data 207 contains up to 27 months of historical charge data, which corresponds to present Medicare limits on collections. In accordance with a further embodiment of the present invention, batch data 207 contains an even longer historical charge data frame of reference, allowing REVBUILDER to track historical charge capture issues for improving billing procedures.

As noted above, the format of charges 204, and also batch data 207, does not correspond to any fixed format. REVBUILDER system 208 is adaptable to obtain data from any number of formats generated by legacy provider system 202, in accordance with an embodiment of the present invention. In the medical context, legacy provider system 202 provides electronic records containing several fields required by standardization practices set forth by the American Medical Association (“AMA”).

The AMA maintains the Current Procedural Terminology (“CPT”) code set, which describes individual medical, surgical, and diagnostic services used to communicate such services in a reliable and consistent manner throughout the medical services industry. Through the use of CPT codes, a charge input for “anesthesia for upper gastrointestinal endoscopic procedures, endoscope induced proximal to duodenum,” is readily codified as CPT code “00740,” for example. Further information regarding CPT codes is available at the AMA-maintained web site “http://www.ama-assn.org/ama/pub/physician-resources/solutions-managing-your-practice/coding-billing-insurance/cpt.shtml”. One skilled in the relevant arts will appreciate that any other standard coding system could be substituted for the CPT code set, although the CPT code set is discussed throughout the specification by way of example, and not limitation, due to the prevalence of its use in the medical services industry.

A medical provider, such as a physician, who delivered the aforementioned anesthesia procedure would be able to enter the CPT code “00740” into the legacy provider system 202 and have the procedure readily recognized. Likewise, when the charge for the procedure is submitted to payer 206, payer 206 will recognize the standardized CPT code as the intended anesthesia procedure.

A similar coding set used for specific items and services provided in the delivery of healthcare is provided for by the Healthcare Common Procedure Coding System (“HCPCS”). The HCPCS is based on the CPT code set, further adding codes directed to non-physician services such as ambulance services and prosthetic devices. Additional information regarding HCPCS is provided at “http://www.ama-assn.org/ama/pub/physician-resources/solutions-managing-your-practice/coding-billing-insurance/cpt/announcements-reports/for-healthcare-common-procedure-coding-system.shtml”. As with CPT, one skilled in the relevant arts will appreciate that HCPCS is another coding system presented by way of example, and not limitation. Other coding systems, such as the Diagnosis Related Group (“DRG”) codes may also be used, in accordance with an embodiment of the present invention.

REVBUILDER 208 is able to leverage the existing standardization of existing robust code sets to understand exactly what procedures were billed for. Additionally, charge data 204 such as included in batch data 207 generally includes a medical record number (“MRN”), which is used to identify a patient, in accordance with an embodiment of the present invention. Charge data also commonly includes, but is not limited to, the date on which a service was performed, the date the charge was posted, the name of a physician who referred the procedure, and the payer responsible for the charge.

Using this data, REVBUILDER 208 is able to identify missing charges and enable service providers to quickly and easily verify the identified missing charges so they can be billed. The means by which REVBUILDER 208 accomplishes this are described in further detail below.

### II. Integration of Rev Builder in Existing Billing Systems

As shown in FIG. 2 and discussed above, REVBUILDER 208 receives batch data 207 from the legacy provider system 202, in accordance with an embodiment of the present invention. This batch data 207 is unobtrusively provided from legacy provider system 202 in a manner that can be readily customized to the needs of a client running the legacy provider system 202. For example, a customer may opt to provide batch data 207 on a monthly basis on fixed media, or may opt to constantly stream the charges to REVBUILDER 208 as they are entered over the Internet or a secured communication link, for example. In accordance with a further embodiment of the present invention, charge data may be entered directly into the REVBUILDER 208 system by a user, such as a physician or a designated individual, for example. One skilled in the relevant arts will appreciate that any number of means exist by which to transfer the charge data from legacy provider system 202 to REVBUILDER 208 for analysis, and the use of batch electronic records is provided by way of example, and not limitation.

As an incentive to encourage users of legacy provider systems 202 to use REVBUILDER 208, a licensing scheme may be employed that enables users to push their batch data 207 to REVBUILDER 208 for analysis free of upfront charges, in accordance with an embodiment of the present invention. In accordance with this embodiment, the users agree to a percentage fee based on collections of missed charges identified by REVBUILDER 208.

This licensing scheme allows users of legacy provider systems 202 to employ REVBUILDER 208 without significant up-front costs, in accordance with an embodiment of the present invention. One skilled in the relevant arts will appreciate that other licensing schemes and financial arrangements may be employed, and the above licensing scheme and financial arrangement is presented by way of example, and not limitation.

Likewise, as the batch data 207 is provided by the client in any format, including, for example, the native format of legacy provider system 202, the labor requirements incurred by the client in using REVBUILDER 208 are minimal. The benefits incurred through the use of REVBUILDER 208 in the identification of otherwise lost charges more likely than not clearly outweighs the minimal level of intrusiveness necessary to begin using REVBUILDER 208.

### III. User Registration

In accordance with an embodiment of the present invention, REVBUILDER system 208 of FIG. 2 is a separate system from legacy provider system 202. One skilled in the relevant arts will appreciate that it is possible to combine the functionality of REVBUILDER 208 into a legacy provider system 202 through additional coding, although the REVBUILDER system 208 is shown as a separate entity by way of example, and not limitation. This allows the REVBUILDER system 208 to operate unobtrusively and without the need for clients running legacy provider system 202 to incur development costs or maintenance costs for REVBUILDER 208.

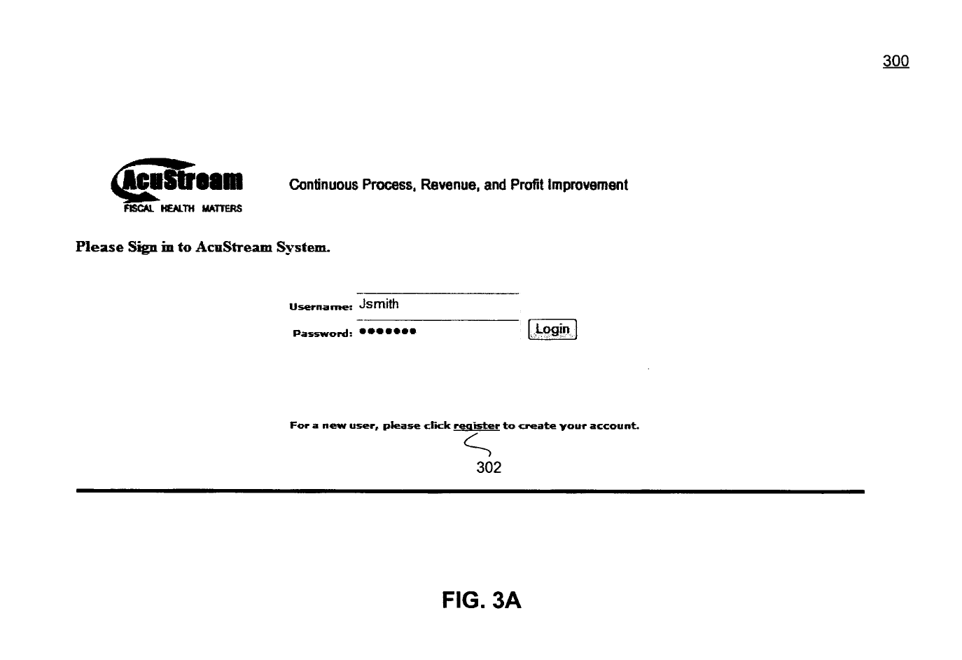

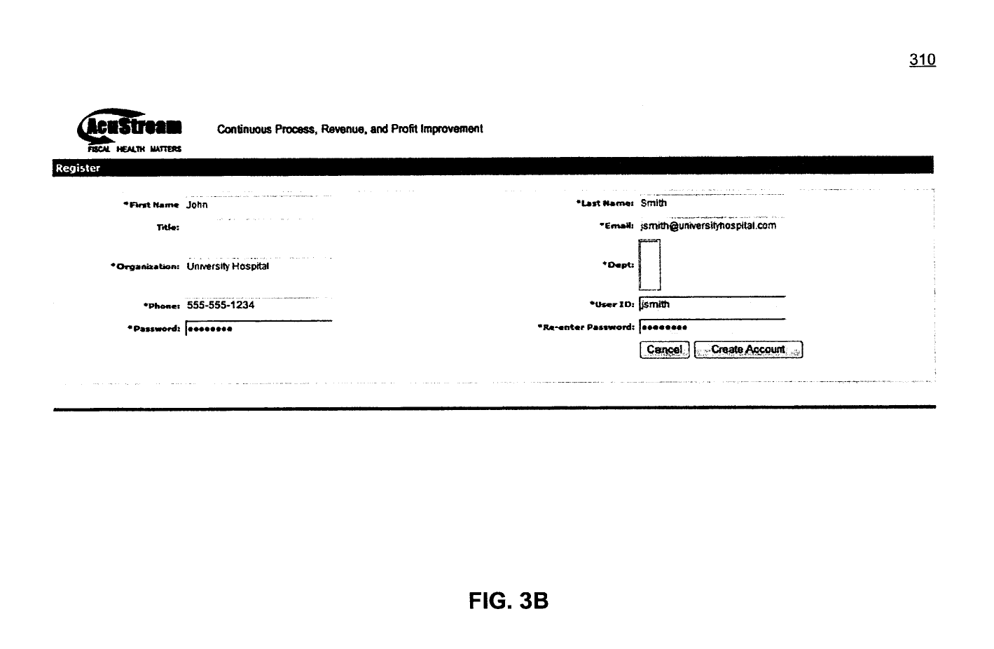

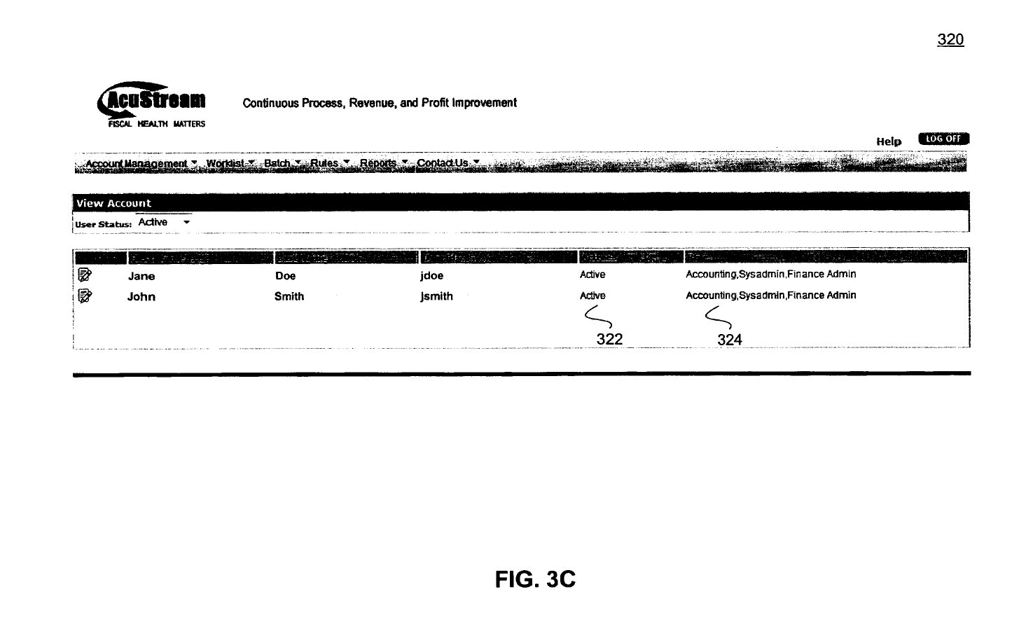

When implemented as a separate system, it is useful to provide user logins and access roles to the necessary users. This is accomplished through the use of login and registration screen 300 of FIG. 3A, in accordance with an embodiment of the present invention. A first-time user of the system can click the “register” link 302 to be taken to a registration screen 310 of FIG. 3B, in accordance with an embodiment of the present invention.

In registration screen 310, the user can enter relevant information in one or more fields, including identifying a department affiliation, in accordance with an embodiment of the present invention. One skilled in the relevant arts will appreciate that the fields displayed in registration screen 310 are not needed in all embodiments, and will also appreciate that additional fields can be useful in certain embodiments. Accordingly, the fields shown in registration screen 310 are presented by way of example, and not limitation. After entering the relevant information, the user is able to select the “Create Account” button 312 to create the account. Upon returning to login screen 300 of FIG. 3A, the user can login using the credentials created in registration screen 310.

FIG. 3C shows an administrator account management view 320, in accordance with an embodiment of the present invention. From this screen, an administrator can select a user for editing, and thereby change the values of one or more data fields. In accordance with an embodiment of the present invention, a field is available to define whether an account is active 322, and thereby permits the associated user to log in to the system. In accordance with a further embodiment of the present invention, an additional field associates the user to one or more roles 324, such as “accounting,” “sysadmin,” or “finance admin.” One skilled in the relevant arts will recognize that an implementation of user roles need not rely on these particular roles, and they are provided herein by way of example, and not limitation.

Though the use of the “active” field, an administrator can allow users to register for accounts using registration screen 310 freely, and can then decide which user accounts to activate. This also gives the administrator an opportunity to ensure that roles are properly assigned. Roles limit a user's access to various parts of the REVBUILDER interface, in accordance with an embodiment of the present invention.

### IV. Rules Creation and Modeling

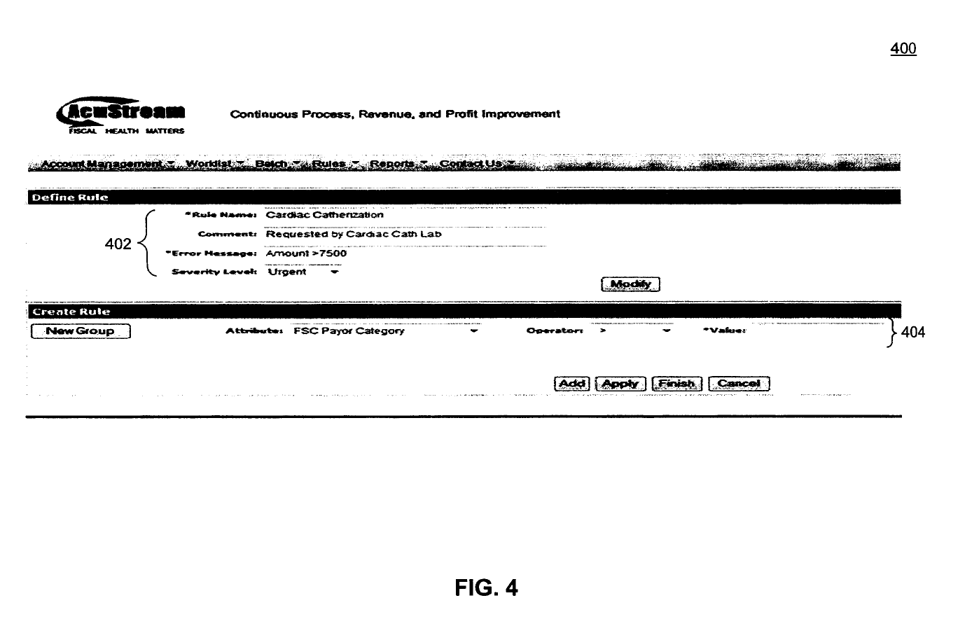

FIG. 4 illustrates a rules creation or modification interface 400, in accordance with an embodiment of the present invention. A user with an appropriate role assignment can access this interface to define rules that will flag behavior detected in a charge data batch. Fields 402 provide the user with the opportunity to define descriptive information regarding the rule, such as its name and severity level. Below, fields 404 define the actual rule requirements by comparing an attribute to a value using an operator, in accordance with an embodiment of the present invention. One skilled in the relevant arts will appreciate that rules can be defined by any number of mathematical or logical operators, and using combinations of more than one of each of attributes, operators, and values to compose an entire expression to be evaluated. Accordingly, the rules discussed throughout this specification should not be seen as limiting the complexity of expressions that can be devised, and are therefore presented by way of example, and not limitation.

Unlike previous systems, which focused on correct entry of charges, REVBUILDER has access to raw charge data after it has been entered and submitted for processing. This provides REVBUILDER with the ability to see every phase of a patient's interaction with a physician or facility, in accordance with an embodiment of the present invention.

Rules designed to identify missed charges use the raw charge data in order to recreate a patient's visit, stay, and/or history, in accordance with an embodiment of the present invention. Through the use of the rules interface 400, rules can be tailored to the particular needs of a client, such as a physician's organization or teaching hospital.

A number of rules can be readily defined to catch commonly missed charges, in accordance with an embodiment of the present invention. Such rules include, by way of example and not limitation:
anesthesia without surgery;
surgery without anesthesia;
inpatient surgery without anesthesia;
outpatient surgery without anesthesia;
anesthesia for radiology procedures without radiology;
pathology without surgery;
evaluation and management without surgery; and
surgery without evaluation and management.

Notably, the aforementioned rules will detect a gap in charges for a procedure that should have been performed as a consequence of another procedure having been performed, in accordance with an embodiment of the present invention. For example, it would be unusual for a sample to have been taken in order to conduct pathology without any surgery having taken place. Rules are written accordingly to account for and flag this behavior as a potential missing charge.

Using the earlier identified CPT codes, a rule for detecting anesthesia without surgery can be written such that if an anesthesiologist provided anesthesia for a cesarean delivery as identified by CPT code “01961,” there must be a charge from the physician that performed the cesarean delivery, which would be identified by CPT code “59510,” in accordance with an embodiment of the present invention. When this rule takes effect, it would look for a CPT code entry of “01961” for a particular MRN. If there is no matching CPT code entry of “59510” for that same MRN, then this is a potential missing charge for the cesarean delivery.

Using sets of these rules, it is possible to construct a patient profile, in accordance with an embodiment of the present invention. This allows one or more rules to be designed to recreate an entire expected patient visit. For example, the majority of patients arriving for treatment for a broken arm will be expected to undergo the exact same sets of procedures. This means that rules can be devised such that the presence of a single charge, such as radiology for a broken arm, would indicate that a series of other charges normally associated with treatment for a broken arm are expected, by way of example and not limitation. Providers are able to use this behavior of the REVBUILDER system to reduce their administrative costs, as it no longer becomes critical to administratively track and capture the individual charges associated with a profile. Additionally, procedures which fail one or more rules of a profile can be used as indicative of outliers, such as a patient coming in for a delivery, which would normally be a vaginal delivery, but instead having a cesarean delivery, in accordance with an embodiment of the present invention.

A profile can also be used to assure that each of the services associated with a patient visit are not only billed, but also performed, in accordance with an embodiment of the present invention. Based on the presence of a single radiology charge up front for a patient visit for a broken arm, the procedures expected to follow can be verified for performance, followed by proper billing.

In accordance with an alternate embodiment of the present invention, the facilities of REVBUILDER 208 may leverage coding sets provided for use in other service or retail environments. By way of example, and not limitation, REVBUILDER 208 can similarly be employed for identifying missed charges in a law firm. Systems for coding charges in the legal context include SERENGETI TRACKER provided by LEGAL SYSTEMS HOLDING COMPANY DBA SERENGETI LAW OF BELLEVUE, WA; CT TYMETRIX 360° provided by CT TYMETRIX of Hartford, Conn.; and AIMS provided by DATACERT of Houston, Tex. Through the use of codes for tasks performed by legal professionals, it is possible to create a rule such as “PTO filing charge without attorney time entry,” for example, or any other rule identifying a missed charge that would be expected to be present as part of a same transaction.

Additional data fields from the charge data can be used to provide further identifying information, in accordance with an embodiment of the present invention. For example, the entry from the anesthesiologist may contain data in a “referring physician” field, which would identify the physician who requested the anesthesia for the cesarean delivery. Likely, this physician is the one who performed the actual delivery, and therefore should be confronted with the missing charge. This information can be displayed to a user to aid in the inquiry into the missing charge, as further shown below.

Additional rules can also help control false positives, in accordance with an embodiment of the present invention. For example, a rule can be added such that the matching CPT code entry “59510” for the above cesarean delivery must be within a 48 hour service date of the anesthesiologist's CPT code “01961” entry (allowing for some variance in the physician's memory regarding the exact time and date at which the procedure was performed). Another rule could be developed such that for charges identified as missing where the referring physician is external to the organization, such as a physician in private practice, that such a charge be ignored. In such a case, the physician would be responsible for identifying and collecting their own charges.

Similarly, a rule can be defined such that a surgery having CPT code entry “59510” without matching anesthesia having CPT code entry “01961” would also break the rule. One skilled in the relevant arts will appreciate that a number of mirroring rule pairs can be defined to detect missing charges. These rules track what a complete visit (or “transaction”) by a particular patient, as represented in the charge data by their MRN, should look like.

In accordance with an embodiment of the present invention, rules can draw on data from additional systems to present a complete picture of a patient's visit, stay, or history. For example, access to only physician information would allow the rule “anesthesia without surgery” to be triggered in appropriate circumstances. However, with additional data from the hospital, it would be possible to write rules such as “surgery without room charges,” or “room charges without physician services.” In this manner, data between physicians and hospitals, or any two or more related entities, can be coordinated to ensure that the complete range of charges for both providers are billed.

When physician and hospital data are combined, mutual benefits in the analysis of charge data for each are achieved. Generally, hospital billings are based on a singular payment for incident of care, such that if a woman gives normal vaginal birth at the hospital facilities, the hospital bills a fixed amount regardless of the length of stay. In the event that the physician ends up performing a cesarean delivery due to complications, the hospital is able to up-charge for the facility usage, and the hospital's charge code should be different and reflect a higher payment. However, due to the segregation of information in legacy systems, it is difficult to reconcile the fact that a physician performed a cesarean delivery instead of a vaginal delivery with the hospital's charges for the usage of their facilities. However, REVBUILDER provides the necessary tools to design rules that can, for example, identify a missing cesarean delivery facility use charge from the hospital when a cesarean delivery is performed by a physician, in accordance with an embodiment of the present invention. Additionally, REVBUILDER can help with the synchronization of charges between the hospital and physicians with respect to data such as the date of services, location, processes, etc.

Rules are defined either globally or on a per-organization basis, in accordance with an embodiment of the present invention. For example, if several hospitals are using the REVBUILDER system, it is likely most if not all would like to implement an “anesthesia without surgery” rule, and therefore the rule can be made global. In other cases, individual clients may have specific needs, and would request the development of rules particular to their situation. Moreover, client charge data may have different data fields available, which may provide more or less information than with other clients, and rules may need to be adjusted accordingly to use available data. In accordance with an embodiment of the present invention, rules are configured to derive necessary data from client charge data in situations where the data is not in a format that is natively compliant with existing rules, such as the use of inconsistent date formats.

As a result, it is possible to use REVBUILDER to develop rules beginning at a high level, gradually increasing the granularity to capture more nuanced missed billings. This allows for rapid development of rules that assist in the capture of the largest missed billings at first, with refinements to recreate complex stays, such as a patient arriving for a vaginal delivery but instead receiving a cesarean delivery.

### V. Applying Rules and Analyzing Results

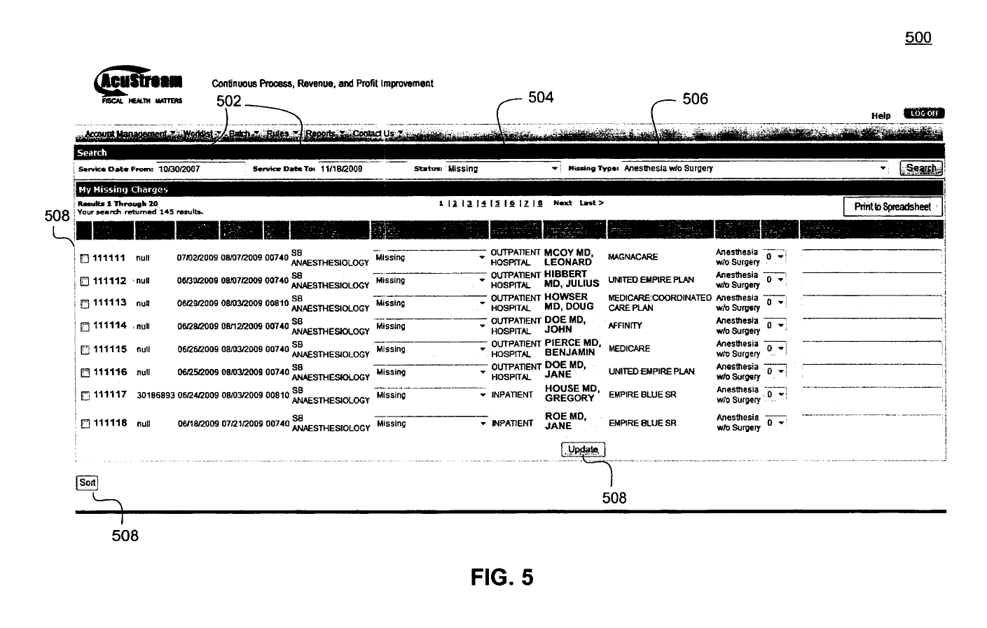

FIG. 5 is a report 500 illustrating missing charges, in accordance with an embodiment of the present invention. Using the interface of report 500, a user is able to select a service date range 502, a status 504 for the entries, and the type 506 of any missing charges. In the report 500, missing charges for surgery where anesthesia was administered between Oct. 30, 2007 and Nov. 18, 2009 are shown.

One such missing charge, indicated by the legend 508, illustrates an exemplary view of a missing charge, in accordance with an embodiment of the present invention. In example 508, anesthesia was administered to a patient having MRN 111111 on Jul. 2, 2009. The anesthesiologist posted the charge on Aug. 7, 2009 with CPT code “00740” (which corresponds to, “anesthesia for upper gastrointestinal endoscopic procedures, endoscope induced proximal to duodenum”). The physician that referred the administration of anesthesia is shown.

The view of report 500 shown in FIG. 5 is adjusted based on the viewing user's role, in accordance with an embodiment of the present invention. In accordance with an embodiment of the present invention, a physician accessing the system can see all missing charges where they are listed as the referring physician. One skilled in the relevant arts will recognize that information regarding the referring physician is not available in all charge data sets, and therefore this usage is provided by way of example, and not limitation.

Additionally, users assigned to a particular department may be assigned a reviewer role for that department, in accordance with an embodiment of the present invention. When a missing charge is identified, it can be associated, either manually or by rule, with the department responsible for the missing charge. This allows one or more responsible individuals to track down the physician who should have performed the service associated with the missing charge to verify that the service was indeed performed.

When any such responsible user has verified that the service was indeed performed, the drop-down “status” menu is selected to move the charge from “missing” to “billed,” in accordance with an embodiment of the present invention. Concurrently, the charge is submitted to the responsible payer, as is shown in the Federal Supply Classification (“FSC”) field, in accordance with an embodiment of the present invention, pursuant to the payer's agreement on charge submission. A comment field allows any relevant information regarding the charge to be entered. One skilled in the relevant arts will recognize that the use of the FSC field to identify the responsible payer is by way of example, and not limitation.

In accordance with an embodiment of the present invention, charges that fail one or more rules are initially placed in a “pending” status, rather than directly into the “missing” status. In accordance with a further embodiment of the present invention, charges are moved from the “pending” status to the “missing” status automatically after some time period (e.g., 90 days) in the event that the charge has not yet been entered.

This delay accounts for physicians who naturally lag in entering their charges, as it is unlikely that both an anesthesiologist and surgeon involved in the same operation will enter their charges at the same time. Accordingly, the delay allows the surgeon some time after the service date entered by the anesthesiologist to enter the corresponding charges for surgery before flagging the surgery as “missing” based on the “anesthesia without surgery” rule, for example. Notably, the charge will still be identified as soon as the charge batch data is analyzed, but the “pending” status provides a grace period for the charge to actually be entered by the surgeon.

If the surgeon subsequently enters the charge, the next execution of the rule will find the anesthesia, look for the surgery, and find it, in accordance with an embodiment of the present invention. Therefore, the “pending” charge would be deleted, as the rule would not flag the charge in subsequent iterations. In accordance with an embodiment of the present invention, charge batch data is received and processed on a monthly cycle, for example, and all previously “pending” or “missing” charges are revisited by a new application of the rules against the data to determine whether the charges have been manually reconciled.

In accordance with a further embodiment of the present invention, charges marked “billed” are rolled-up during the processing of a subsequent charge batch data and matched with the actual charges. For example, if a missing charge is verified and marked as billed by a user, the next time batch data comes in, the data should contain a charge corresponding to the billed entry. If it does, then the billed entry is moved to an additional status called “resolved,” indicated that it has successfully been submitted for processing, in accordance with an embodiment of the present invention.

However, if the charge is not present in a subsequent data batch, the charge is reverted to the “missing” state for further resolution, in accordance with an embodiment of the present invention.

In accordance with an embodiment of the present invention, a drop-down menu is provided to allow a user to select which department should receive the missing charge information. This, along with any comments or changes in status, is updated by making the changes and selecting the “Update” button 512.

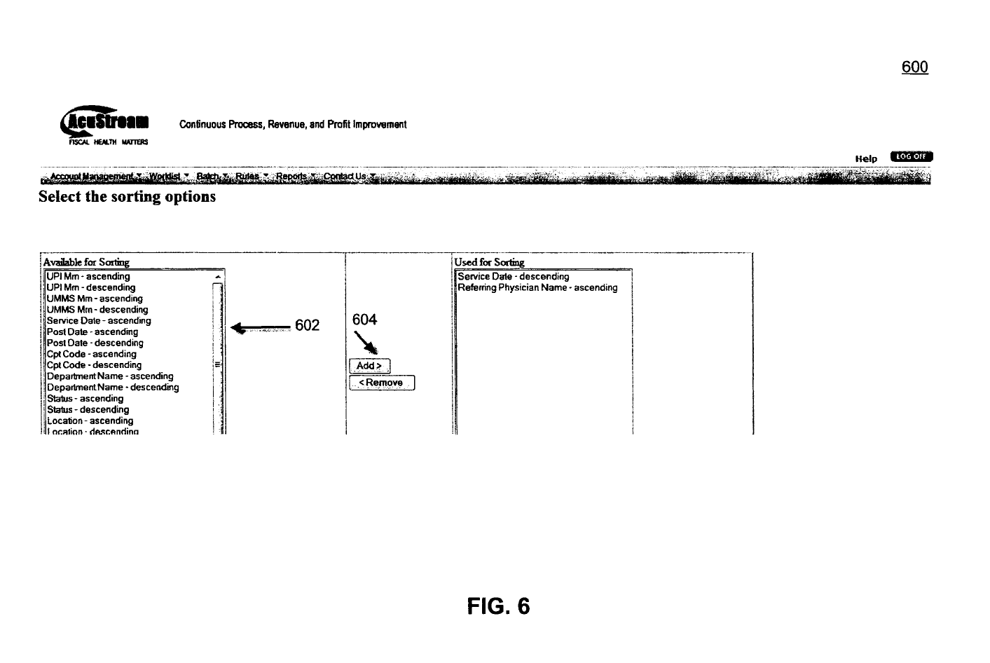

It is further possible to select a sort order for the missing charges by selecting the “Sort” button 510, in accordance with an embodiment of the present invention. Selecting the “Sort” button 510 opens sorting options display 600 of FIG. 6, in accordance with a further embodiment of the present invention. A list of fields available for sorting 602 allows the selection of individual sorting criteria, which can then be added to the sorting criteria using the “add >” button 604. Entries in report 500 of FIG. 5 are then sorted according to the sorting criteria, in accordance with an embodiment of the present invention. Other sorting and/or ordering of fields and data can be performed in accordance with an embodiment of the present invention without departing from the scope and teachings described herein.

### VI. Batch Uploads

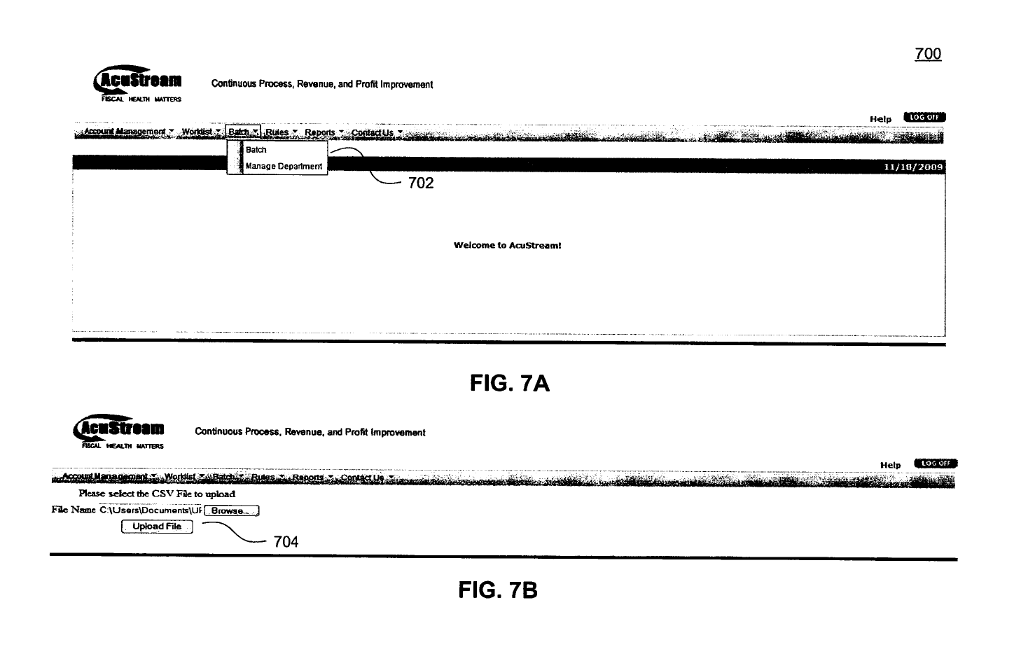

FIG. 7A is a view 700 of the REVBUILDER interface with the “Batch” menu 702 selected, in accordance with an embodiment of the present invention. When the batch option is selected, the batch interface 704 of FIG. 7B is displayed, in accordance with a further embodiment of the present invention.

Batch interface allows for the specification of a Comma-Separated Value (“CSV”) file to use as the source for a batch upload of charge data. One skilled in the relevant arts will appreciate that the interface can be designed to handle input via other formats aside from CSV, including proprietary formats used by legacy provider systems. The use of CSV files is provided by way of example, and not limitation.

A CSV file will commonly include data that can be directly correlated to several fields of report 500, or from which those fields can be derived, in accordance with an embodiment of the present invention. This will generally include a patient's MRN, a service date, post date, CPT code, referring physician, and payer information, although additional or fewer fields may be available in any given implementation.

When the file is selected for import, the imported charge data is stored in a local database for further analysis, in accordance with an embodiment of the present invention. Rules are run against the data as stored in the local database for improved performance, and also to enable queries to be quickly and readily derived from the rule expressions. In accordance with an additional embodiment of the present invention, each charge of the imported charge data is given a unique identifier within the local database to act as a key for the charge.

### VII. Generating and Delivering Reports

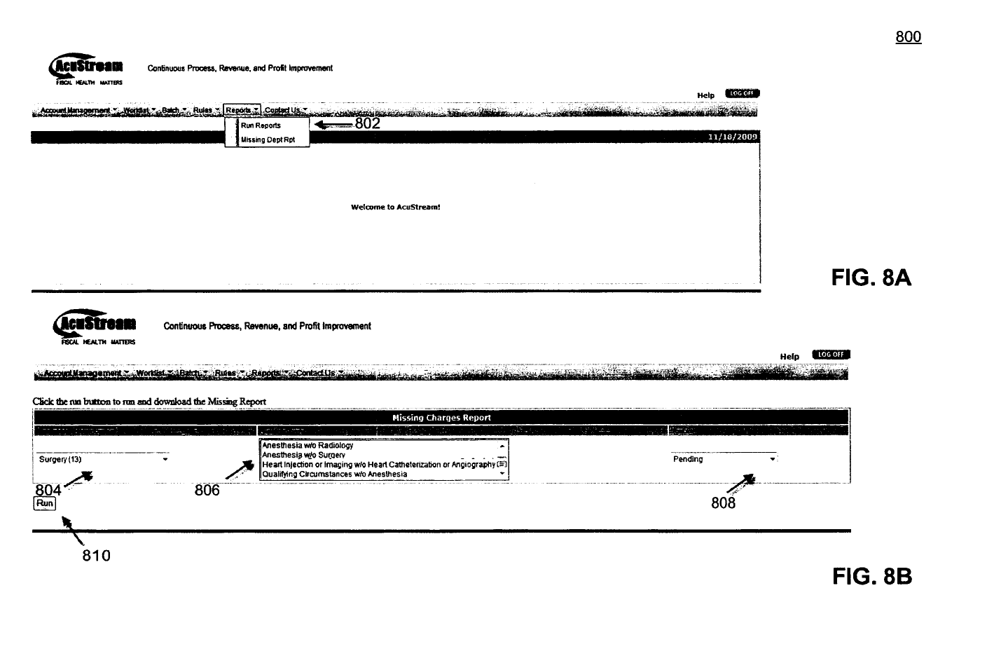

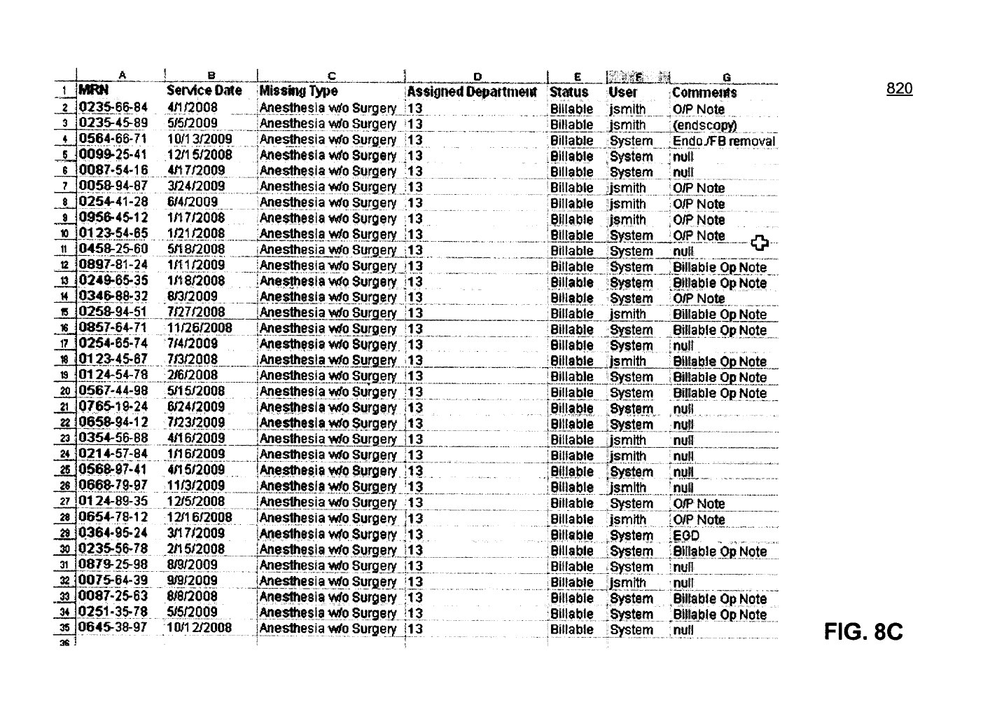

FIG. 8A is a view 800 of the REVBUILDER interface with the “Reports” menu 802 selected, in accordance with an embodiment of the present invention. When the “Run Reports” option is selected, the missing charges report of FIG. 8B is displayed, in accordance with a further embodiment of the present invention.

By using this interface, it is possible to generate reports for easy viewing and processing by external programs, or for electronic or hard copy delivery to interested parties. Menus allow for the selection of a department 804 associated with the missing charges sought to be displayed, one or more types of missing charges 806, corresponding to rules, and the status of the missing charges 808, in accordance with an embodiment of the present invention. For example, a user may select to generate a report with only missing charges (i.e., those that have been moved by the system from “pending” to “missing” after some time period delay). The report is generated by selecting the “Run” button 810, in accordance with an embodiment of the present invention. FIG. 8C illustrates a resulting sample report 820 output in CSV format and opened in Microsoft Excel for viewing, in accordance with an embodiment of the present invention.

The ability to visualize data in this manner, and also through the use of report 500, allows for the detection of systematic delays and errors in charge entry. This allows for the identification of problem departments or individual physicians who routinely miss charges, and provides the organization with the ability to mitigate these issues by targeted policies or additional training, in accordance with an embodiment of the present invention. In accordance with a further embodiment of the present invention, report 500 can show system failures, such as missing data from an entire department indicating a system failure in that department's systems. Report 500 also assists in the identification of compliance issues such as duplicate billing, provider, location, and service date errors.

Moreover, it is possible to improve production by modifying the timeframe in which a missing charge goes from the “pending” state to the “missing” state. Training can be targeted at those users who routinely allow charges to be missed long enough to be detected as “missing,” with incentives to users with the lowest pendency in reconciling their charges. In this manner, REVBUILDER provides visibility into charge entries at a level at which excellence in billing can be determined and actions can be taken to reward or support process issues. The ability to visualize not only the fact that charges are being missed, but which groups and individuals are responsible for the missed or delayed charges, as well as the amount of time it takes for the groups and individuals to resolve missing charges, provides significant benefits to an organization working towards full collections. One skilled in the relevant arts will appreciate that the data made available by this process can be visualized in other manners that can provide a useful picture of missing charge behavior, and the aforementioned visualizations are provided by way of example, and not limitation.

The ability to visualize all of this data results in a feedback loop that continuously makes rules targeted to an individual, department, group, enterprise, or system-wide level smarter and more effective. Charge data, along with any other data made available by a provider to REVBUILDER (e.g., payment, schedule, payer obligations, hospital charges) together with the interaction of users at the interface (e.g., marking status as non-billable physician, non-billable department, non-billable procedure, or any other communication, such as to indicate that a physician is not part of the provider's billing system) continuously improves the rules. Likewise, the continuous information that becomes available to REVBUILDER allows for the generation of reports detailing what procedures and physicians or departments bills are being generated for, therefore improving the provider's level of knowledge.

### VIII. Algorithmic Implementation

Advantages of embodiments of the present invention have been described in the context of the user interface. Additional insight is provided herein regarding the processing involved in order to produce the visual reports.

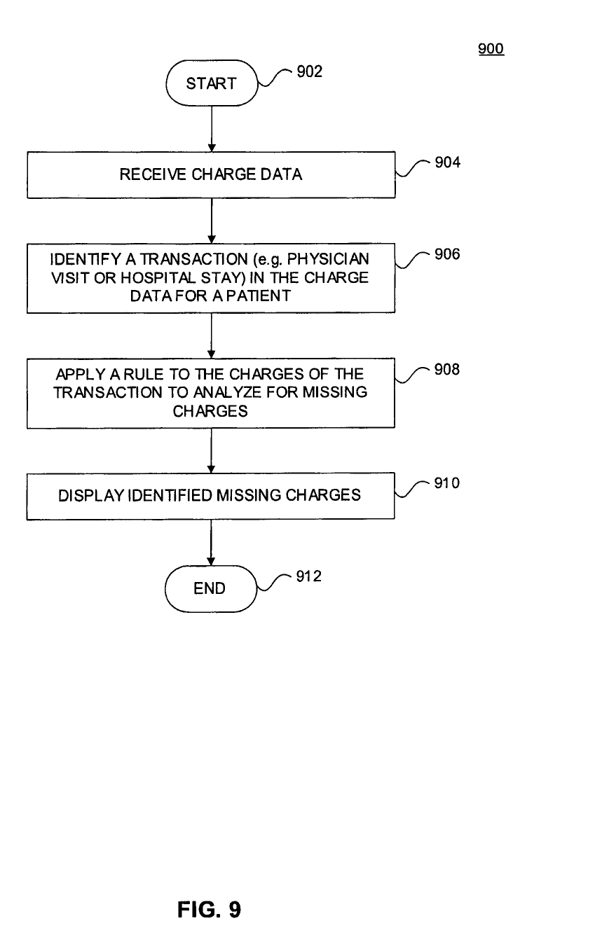

FIG. 9 is a flowchart 900 illustrating steps by which a report showing identified missing charges is generated, in accordance with an embodiment of the present invention. The method begins at step 902 and proceeds to step 904 where charge data is received. Charge data may be received in a number of formats and by any number of communication mechanisms, as will be readily apparent to one skilled in the relevant arts. Receiving in this context comprises the retrieval or access of the charge data from a medium in which the charge data is stored or through which the charge data is being transmitted, in accordance with an embodiment of the present invention, and therefore the terms “receiving,” “retrieving,” and “accessing,” and derivatives thereof, are used interchangeably. In accordance with a further embodiment of the present invention, charge data is received at step 904 via the batch upload mechanism described in Section VI, supra.

At step 906, a transaction is identified within the charge data, in accordance with an embodiment of the present invention. At step 908, a rule is applied to analyze the charges in the transaction for any missing charges, in accordance with a further embodiment of the present invention. One skilled in the relevant arts will recognize that steps 906 and 908 can be implemented by a combination of one or more rules, depending on the complexity of the task, and is illustrated as separate rules by way of example, and not limitation.

Step 906 clarifies that charge data for a single patient, based on the patient's MRN, is analyzed, in accordance with an embodiment of the present invention. As previously described, a date range for analysis is provided by a rule in order to more accurately recreate a single patient visit, in accordance with a further embodiment of the present invention. This single visit, comprised of one or more charges, is what is termed a “transaction.” Then, at step 908, the charges that comprise the transaction are analyzed through application of one or more rules to determine whether any charges are missing for that visit. As previously discussed in Section IV, supra, any visit that involved surgery would likely have involved anesthesia. If a surgery charge is present within a transaction, but a corresponding anesthesia charge is not present within the same transaction, then the anesthesia charge is identified as a missing charge.

At step 910, all such missing charges are displayed in a report, such as report 500 of FIG. 5. The method ends at step 912.

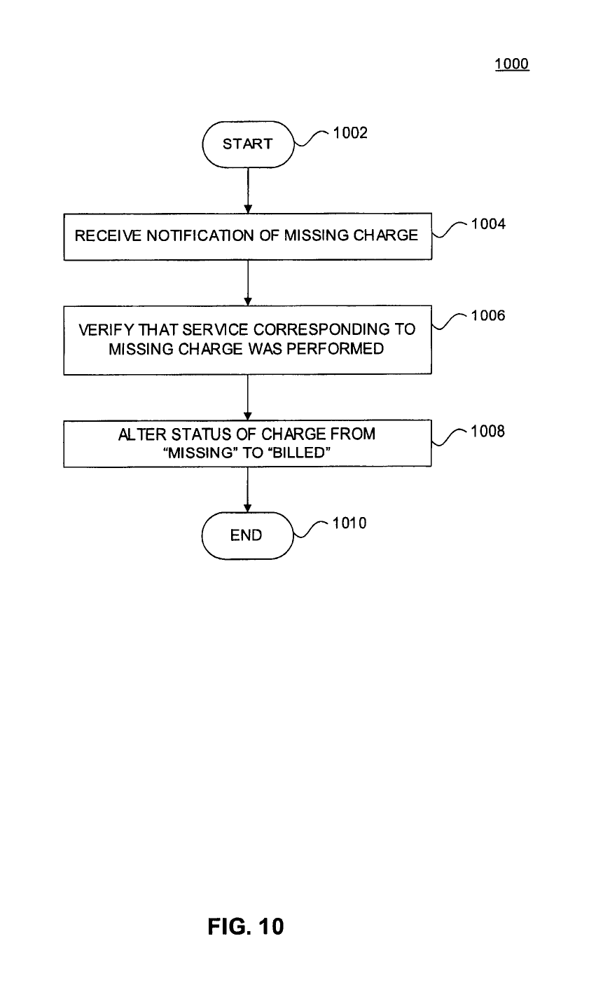

FIG. 10 is a flowchart 1000 illustrating steps by which missing charges are reconciled by a user, in accordance with an embodiment of the present invention. The method begins at step 1002 and proceeds to step 1004 where the user receives notification of a missing charge. This notification is received, in accordance with an embodiment of the present invention, by display on the user's view of report 500.

If a particular physician has been identified as the physician responsible for the missing charge, for example by virtue of the physician being listed as the referring physician in a companion charge (e.g., anesthesia where the surgeon missed the corresponding companion surgery charge), the missing charge is displayed on that physician's view of report 500, in accordance with an embodiment of the present invention. In accordance with a further embodiment of the present invention, a user responsible for missing charges within a department will have the missing charge listed in that user's view of report 500.

Other means of notifying one or more users of missing charges can be used. For example, the system can be configured to generate and send an e-mail notifying an interested user (e.g., the physician or user responsible for missing charges within a department as above) that the information is available through the REVBUILDER system, prompting the user to log in to confirm, in accordance with an embodiment of the present invention. The REVBUILDER system can also be configured to generate paper reports notifying interested users of the missing charges, in accordance with a further embodiment of the present invention. Other notification and reporting techniques can be used as would become apparent to persons having ordinary skill in the art.

At step 1006, a user, such as the recipient of the notification of step 1004, verifies that the service indicated by the missing charge was actually carried out, in accordance with an embodiment of the present invention. This means, for example, that if a missing charge is identified due to anesthesia having been administered without surgery, verification is carried out, by an administrative assistant, or the like, to confirm that the responsible surgeon actually did perform the expected surgery. Once this is confirmed, the status of the missing charge can be altered from “missing” to “billed” at step 1008, and the charge should then be billed out to the payer. The method ends at step 1010.

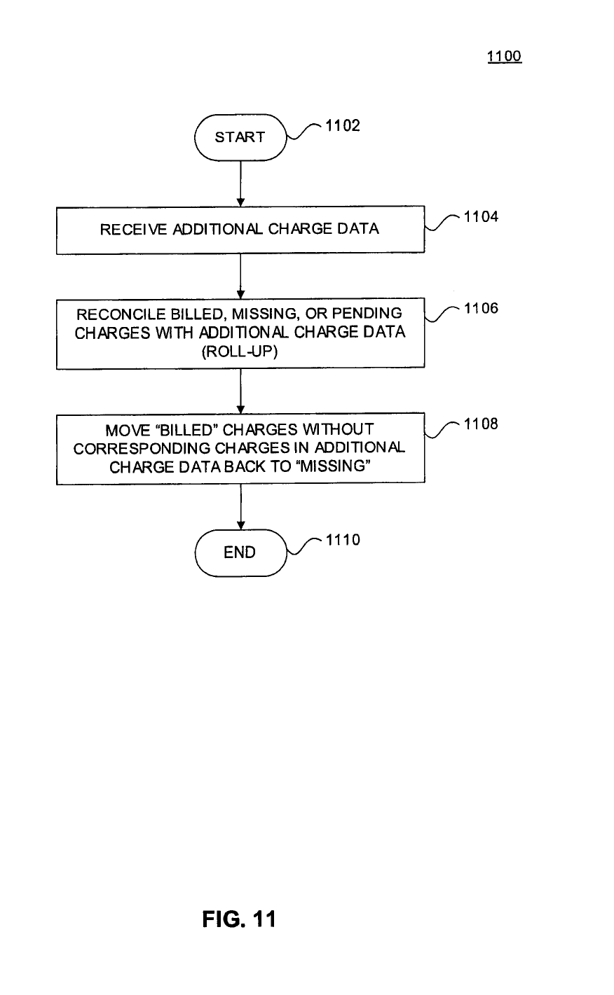

FIG. 11 is a flowchart 1100 illustrating steps by which a data roll-up occurs, in accordance with an embodiment of the present invention. The method begins at step 1102 and proceeds to step 1104 where additional charge data is received. In accordance with an embodiment of the present invention, batch charge data is received at the end of every month. In this scenario, charges marked as “billed” in the previous monthly cycle have an entire month, for example, in which to have actually proceeded through the motions for billing out to the payer.

At step 1106, the additional charge data is reconciled with the existing charge data, in accordance with an embodiment of the present invention. Charges that were “billed” in the last cycle that now appear in the additional charge data would satisfy rules that would have otherwise marked the now-present charge as “missing.” As a result, the charge is moved from the “billed” state to a “resolved” state, in accordance with a further embodiment of the present invention.

Also at step 1106, any charges marked “pending” that still do not appear in the additional charge data, and that are now beyond any grace period identified by the REVBUILDER rules or software, are moved to the “missing” state, in accordance with an embodiment of the present invention.

Additionally, at step 1108, charges marked as “billed” with no reconciling charges in the next batch are moved back to the “missing” state to allow users to view and address the missing charge data, in accordance with an embodiment of the present invention. Items in the “billed” state that were moved there from the “missing” state by a user subsequent to verification of the underlying service having been performed will need to eventually be billed out. When they are actually billed out to the payer, the actual charge, rather than the placeholder “missing” (now “billed”) charge, will appear in the additional charge data. The lack of this charge in the additional charge data means that the charge was never actually billed out, and should be addressed by a user. The method then ends at step 1110.

### IX. Example Computer System Implementation

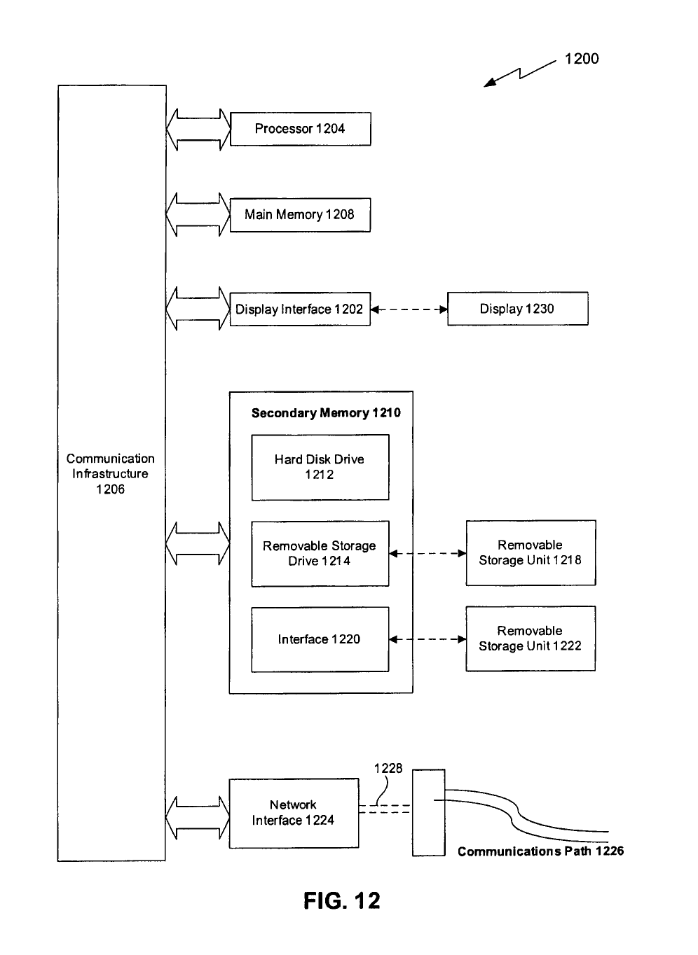

Various aspects of the present invention can be implemented by software, firmware, hardware, or a combination thereof. FIG. 12 illustrates an example computer system 1200 in which the present invention, or portions thereof, can be implemented as computer-readable code. For example, the methods illustrated by flowcharts 900 of FIG. 9, 1000 of FIG. 10, and 1100 of FIG. 11, can be implemented in system 1200. Various embodiments of the invention are described in terms of this example computer system 1200. After reading this description, it will become apparent to a person skilled in the relevant art how to implement the invention using other computer systems and/or computer architectures.

Computer system 1200 includes one or more processors, such as processor 1204. Processor 1204 can be a special purpose or a general purpose processor. Processor 1204 is connected to a communication infrastructure 1206 (for example, a bus or network).

Computer system 1200 also includes a main memory 1208, preferably random access memory (RAM), and may also include a secondary memory 1210. Secondary memory 1210 may include, for example, a hard disk drive 1212, a removable storage drive 1214, and/or a memory stick. Removable storage drive 1214 may comprise a floppy disk drive, a magnetic tape drive, an optical disk drive, a flash memory, or the like. The removable storage drive 1214 reads from and/or writes to a removable storage unit 1218 in a well known manner. Removable storage unit 1218 may comprise a floppy disk, magnetic tape, optical disk, etc. which is read by and written to by removable storage drive 1214. As will be appreciated by persons skilled in the relevant art(s), removable storage unit 1218 includes a computer usable storage medium having stored therein computer software and/or data.

In alternative implementations, secondary memory 1210 may include other similar means for allowing computer programs or other instructions to be loaded into computer system 1200. Such means may include, for example, a removable storage unit 1222 and an interface 1220. Examples of such means may include a program cartridge and cartridge interface (such as that found in video game devices), a removable memory chip (such as an EPROM, or PROM) and associated socket, and other removable storage units 1222 and interfaces 1220 which allow software and data to be transferred from the removable storage unit 1222 to computer system 1200.

Computer system 1200 may also include a communications interface 1224. Communications interface 1224 allows software and data to be transferred between computer system 1200 and external devices. Connectivity to external devices using communications interface 1224 may be direct, or via a local or wide area network, such as the Internet. Communications interface 1224 may include a modem, a network interface (such as an Ethernet card), a communications port, a PCMCIA slot and card, or the like. Software and data transferred via communications interface 1224 are in the form of signals which may be electronic, electromagnetic, optical, or other signals capable of being received by communications interface 1224. These signals are provided to communications interface 1224 via a communications path 1226. Communications path 1226 carries signals and may be implemented using wire or cable, fiber optics, a phone line, a cellular phone link, an RF link or other communications channels.

In this document, the terms “computer program medium” and “computer usable medium” are used to generally refer to media such as removable storage unit 1218, removable storage unit 1222, and a hard disk installed in hard disk drive 1212. Signals carried over communications path 1226 can also embody the logic described herein. Computer program medium and computer usable medium can also refer to memories, such as main memory 1208 and secondary memory 1210, which can be memory semiconductors (e.g., DRAMs, etc.). These computer program products are means for providing software to computer system 1200.

Computer programs (also called computer control logic) are stored in main memory 1208 and/or secondary memory 1210. Computer programs may also be received via communications interface 1224. Such computer programs, when executed, enable computer system 1200 to implement the present invention as discussed herein. In particular, the computer programs, when executed, enable processor 1204 to implement the processes of the present invention, such as the steps in the methods illustrated by flowcharts 900 of FIG. 9, 1000 of FIG. 10, and 1100 of FIG. 11, discussed above. Accordingly, such computer programs represent controllers of the computer system 1200. Where the invention is implemented using software, the software may be stored in a computer program product and loaded into computer system 1200 using removable storage drive 1214, interface 1220, hard drive 1212 or communications interface 1224.

In accordance with an embodiment of the present invention, aspects of the invention are separated into individual modules. These modules may each be implemented by a combination of hardware and software components. One skilled in the relevant arts will recognize that there are numerous ways to modularize hardware and software components, and accordingly any modularization described herein is provided by way of example, and not limitation.

The invention is also directed to computer program products comprising software stored on any computer useable medium. Such software, when executed in one or more data processing device, causes a data processing device(s) to operate as described herein. Embodiments of the invention employ any computer useable or readable medium, known now or in the future. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nanotechnological storage device, etc.), and communication mediums (e.g., wired and wireless communications networks, local area networks, wide area networks, intranets, etc.).

### X. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. It should be understood that the invention is not limited to these examples. The invention is applicable to any elements operating as described herein. Accordingly, the breadth and scope of the present invention should not be limited by any of the above-described exemplary embodiments, but should be defined only in accordance with the following claims and their equivalents.

What is claimed is:

1. A method comprising:
accessing charge data in one or more processors;
identifying, in the one or more processors, a transaction in the charge data corresponding to an identifier, the transaction comprising one or more charges in the charge data;
applying, in the one or more processors, a rule to identify a missing charge within the transaction; and
transmitting, in the one or more processors, a notification to a verifier of the missing charge.

2. The method of claim 1, wherein transmitting the notification to the verifier of the missing charge comprises:
identifying a referrer in the one or more charges of the transaction; and
transmitting the notification to the verifier, wherein the verifier belongs to a department associated with the referrer.

3. The method of claim 2, further comprising:
receiving verification from the verifier that a service corresponding to the missing charge was performed; and
marking the missing charge as having a billed status.

4. The method of claim 3, further comprising:
billing for the missing charges.

5. The method of claim 3, further comprising:
accessing additional charge data, the additional charge data representing a subsequent time period from the charge data;
searching the additional charge data for the missing charge;
reverting the missing charge from the billed status to missing if the missing charge is not present within the additional charge data; and
marking the missing charge as resolved if the missing charge is present within the additional charge data.

6. The method of claim 2, wherein identifying the referrer in the one or more charges of the transaction comprises:
permitting identification of the referrer by completion of the referrer field.

7. The method of claim 1, wherein applying the rule to identify the missing charge within the transaction comprises:
identifying the presence of a performed charge within the charge data, wherein the rule is designed to indicate, based on the presence of the performed charge, that a service corresponding to the missing charge was performed.

8. The method of claim 1, wherein each charge of the charge data comprises a medical record number and a charge code indicating a performed service corresponding to the charge.

9. The method of claim 1, further comprising:
generating at least one of a paper and electronic report comprising the missing charge.

10. The method of claim 1, further comprising:
receiving additional charge data from a second source, separate from a first source, from which the charge data is received; and
applying a rule to identify a missing charge within the transaction, wherein the rule is based on charges from the charge data and the additional charge data.

11. A computer-readable medium having computer-executable instructions stored thereon that, upon execution by a computing device, cause the computing device to perform a method comprising:
accessing charge data;
identifying a transaction in the charge data corresponding to an identifier, the transaction comprising one or more charges in the charge data;
applying a rule to identify a missing charge within the transaction; and
transmitting a notification to a verifier of the missing charge.

12. The computer-readable medium of claim 11, wherein transmitting the notification to the verifier of the missing charge comprises:
identifying a referrer in the one or more charges of the transaction; and
transmitting the notification to the verifier, wherein the verifier belongs to a department associated with the referrer.

13. The computer-readable medium of claim 12, the method performed thereby further comprising:
receiving verification from the verifier that a service corresponding to the missing charge was performed; and
marking the missing charge as having a billed status.

14. The computer-readable medium of claim 13, the method performed thereby further comprising:
billing for the missing charges.

15. The computer-readable medium of claim 13, the method performed thereby further comprising:
accessing additional charge data, the additional charge data representing a subsequent time period from the charge data;
searching the additional charge data for the missing charge;
reverting the missing charge from the billed status to missing if the missing charge is not present within the additional charge data; and
marking the missing charge as resolved if the missing charge is present within the additional charge data.

16. The computer-readable medium of claim 12, wherein identifying the referrer in the one or more charges of the transaction comprises:
permitting identification of the referrer by completion of the referrer field.

17. The computer-readable medium of claim 11, wherein applying the rule to identify the missing charge within the transaction comprises:
identifying the presence of a performed charge within the charge data, wherein the rule is designed to indicate, based on the presence of the performed charge, that a service corresponding to the missing charge was performed.

18. The computer-readable medium of claim 11, wherein each charge of the charge data comprises a medical record number and a charge code indicating a performed service corresponding to the charge.

19. The computer-readable medium of claim 11, the method performed thereby further comprising:
generating at least one of a paper and electronic report comprising the missing charge.

20. The computer-readable medium of claim 11, the method performed thereby further comprising:
receiving additional charge data from a second source, separate from a first source, from which the charge data is received; and
applying a rule to identify a missing charge within the transaction, wherein the rule is based on charges from the charge data and the additional charge data.

21. A system comprising:
a memory configured to store modules comprising:
an accessing module configured to access charge data,
an identifying module configured to identify a transaction in the charge data corresponding to an identifier, the transaction comprising one or more charges in the charge data,
an applying module configured to apply a rule to identify a missing charge within the transaction, and
a transmitting module configured to transmit a notification to a verifier of the missing charge; and
one or more processors configured to process the modules.

22. A method comprising:
providing charge data to a computing device configured to identify a missing charge corresponding to a transaction within the charge data;
accessing the missing charge from the computing device;
verifying that a service corresponding to the missing charge was performed;
updating the status of the missing charge in the computing device; and
submitting subsequent charge data to the computing device further configured to reconcile the missing charge with the subsequent charge data.

23. A method comprising:
accessing charge data in one or more processors;
identifying, in the one or more processors, a transaction in the charge data corresponding to an identifier, the transaction comprising one or more charges in the charge data;
applying, in the one or more processors, a rule profile to identify a charge related to at least one charge of the transaction; and
transmitting, in the one or more processors, a notification to a verifier of the related charge, without requiring separate entry of the related charge.
